(19) United States
(12) Patent Application Publication
(10) Pub. No.: US 2018/0229059 A1
(43) Pub. Date: Aug. 16, 2018

(54) COUPLING HOUSING

(71) Applicant: James Glazier, Incline Village, TX (US)

(72) Inventor: James Glazier, Incline Village, TX (US)

(21) Appl. No.: 15/892,729

(22) Filed: Feb. 9, 2018

Related U.S. Application Data
(60) Provisional application No. 62/457,414, filed on Feb. 10, 2017.

(51) Int. Cl. A62B 3/00; B61B 7/00

(52) U.S. Cl. CPC A62B 3/00; B61B 7/00

(57) ABSTRACT

A system and method for a coupling housing. The housing houses a coupling, such as a cable. The housing is coupled to a lift via an attaching device. The coupling can be lowered down to secure to ground equipment. This allows a stranded lift, such as a ski lift, to be properly secured to the ground equipment. This allows for the safe and efficient removal of any stranded passengers.

### PRIORITY

The present invention claims priority to Provisional Application No. 62/457,414 filed Feb. 10, 2017 entitled “Coupling Housing”, the entirety of which is hereby incorporated by reference.

### BACKGROUND OF THE INVENTION

### Technical Field

The present invention relates to a system and method for coupling a ground crew to a ski lift.

### Description of Related Art

Aerial lifts, also known as a ski lift, may become disabled and unusable during a tinge of operation stranding occupants above the ground. Often the ground crew must climb and traverse the cables in order to properly secure ground equipment to the disabled ski lift. This often occurs during inclement weather during which it is often unsafe for the ground crew as well as the ski lift occupants. Consequently, there is a need to better assist a ground crew to retrieve and rescue stranded occupants.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a disabled ski lift;

FIG. 2 is a perspective view of a cable housing in one embodiment;

FIG. 3 is a perspective view of a cable housing in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

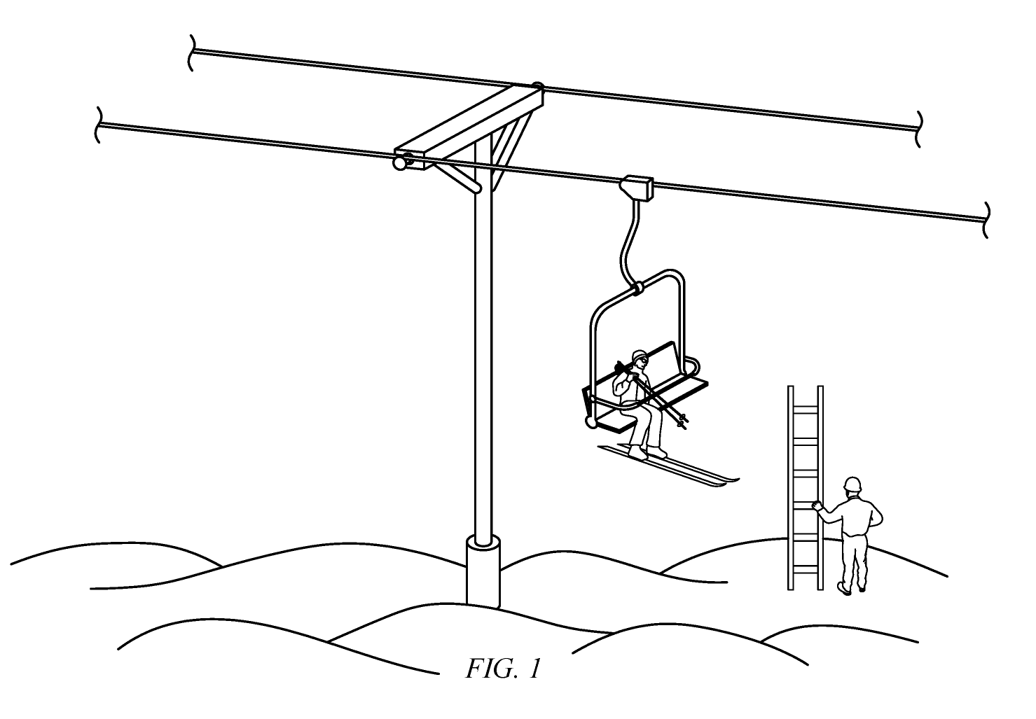

FIG. 1 is a perspective view of a disabled ski lift 101 in one embodiment. While a ski lift is described, this is for illustrative purposes only and should not be deemed limiting. The cable housing can be used in virtually any elevated cab. This includes aerial cabs in amusement parks, scenic outlooks, etc. Virtually any cab which is elevated and used to transport people from one location to another in an elevated manner can be utilized. Thus, while the application makes reference to a ski lift, this is for illustrative purposes only.

In FIG. 1, a ski lift 101 is shown being supported by two ski lift supports 103. While two ski lift supports 103 are shown, this is for illustrative purposes only. In other embodiments, for example, ski lifts comprise only one ski lift supports 103, whereas in still other embodiments more than two ski lift supports 103 are utilized. The ski lift supports 103 are often large cables which are coupled to a ski lift 101 and which transports, supports, and moves the ski lift 101. The ski lift supports 103 are further supported by a plurality of ski lift structures 102.

For a variety of reasons the ski lift 101 can become stuck. This can involve technical malfunctions, inclement weather, loss of electrical power, etc. When this happens, the ski lift's 101 occupants are left stranded suspended in the ski lift 101. Ground personnel have equipment 104, which can comprise ladders, trucks, manlifts, etc., which can be used to retrieve the occupants from the stranded ski lift 101. As used herein, ground equipment 104 refers to any equipment which is used to retrieve stranded occupants from a ski lift. However, it is often difficult to couple the ground equipment 104 to the ski lift 101. It can be appreciated that if the ladder, as an example, is not properly coupled to the ski lift 101, then removing the stranded occupants via the ladder is not safe. Thus, it is generally desirable that the ground equipment 104 be properly coupled to the ski lift 101. As noted, often ground personnel must climb a structure 102 in effort to couple the ski lift 101 to the ground equipment 104. However, this is often difficult as the weather can be inclement rendering climbing conditions non-ideal.

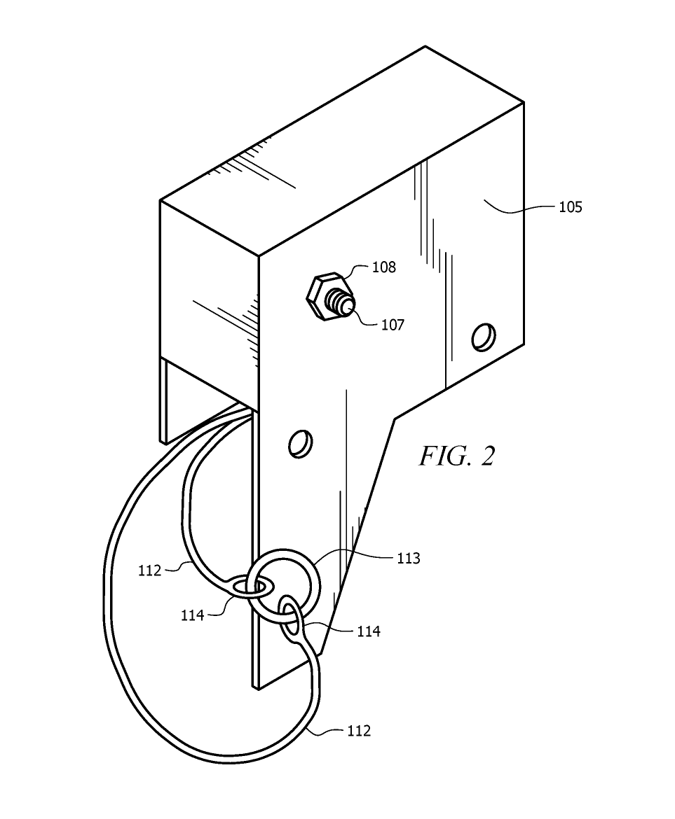

FIG. 2 is a perspective view of a coupling housing in one embodiment. A coupling housing, as used herein, refers to a housing which stores a coupling device. The coupling device is used to couple the ski lift 101 to the ground equipment 104. The coupling device can comprise a rope, a wire, a cable, a chain, a mechanical adapter or other couples, which can be used to couple to ground equipment 104. One embodiment will be described wherein the coupling is a cable, but this is for illustrative purposes only and should not be deemed limiting.

A coupling housing 105 couples, either directly or indirectly, to a ski lift 101. In one embodiment it is stored on a ski lift 101 so as to not to interfere with the entering and exiting of the occupants. In one embodiment the coupling housing 105 is stored to a side of the ski lift 101. In one embodiment the housing 105 is coupled so as to permanently stored adjacent to or within the lift 101. In one embodiment the housing 105 is welded to the lift 101. In other embodiments the housing 105 is secured via bolts, screws, or the like.

The location of the housing 105 relative to the lift can vary depending upon the lift design. In some embodiments, the housing 105 is coupled to the outer surface of the lift 101. As an example, in one embodiment the housing 105 is secured under the chair. This is a benefit because it is out of sight. In other embodiments the housing 105 is coupled to the left or right side of the lift. In one embodiment the housing 105 is stored so as to not prevent passengers from entering or exiting the lift 101.

Lifts 101 are not of uniform shape or design. Some lifts have a bar that comes up to offer support, others have a bar that come down, or even swing from the side. Accordingly, the housing 105 shape, size, and design, can vary depending upon the size, shape, and operation of the lift.

As noted, the coupling housing 105 houses a coupling 112 which can couple to the ground equipment 104. In the example wherein the coupling 112 comprises a cable, the cable can be retrieved from the housing 105, and lowered to the ground personnel. The ground personnel can then adhere or couple the coupling to the equipment 104. This aids the ground personnel is securely and safely retrieving the stranded occupants.

The length of the coupling 112 can vary. In one embodiment, the coupling comprises sufficient length to reach to the ground. Thus, in one embodiment the coupling 112 comprises a length of greater than 20 feet.

In FIG. 2, the coupling is depicted as having a closed end. A closed end is where each end of the coupling is attached to the coupled housing such that the ground personnel are presented with a loop. In this fashion, the ground personnel can manipulate the loop to couple and secure it to the ground equipment. In other embodiments, however, the coupling comprises an open end. An open end is where at least one end of a coupling is free to be presented to the ground personnel. In this fashion, the ground personnel will use the free end of the coupling to tie or secure the coupling to the ground equipment.

In one embodiment the housing comprises a weather protected housing and is attached to an aerial lift, such as a ski lift. A weather protected housing ensures that the coupling, such as a cable, is not worn or damaged by the elements. As noted, when deployed, ground personnel will use the coupling to place evacuation equipment for their use in evacuation of stranded users of the aerial lift. In one embodiment the coupling allows evacuation personnel a more rapid method of placing evacuation equipment when needed. The attachment of a weather resistant housing, enclosing a reel, holding a length of cable, which the occupant of an aerial lift can deploy to ground personnel, will speed the evacuation. The attachment method to the aerial lift may vary due to design differences of manufactures and models.

In one embodiment the coupling housing comprises an external protective sheath. As used herein, an external protective sheath refers to a covering which covers the coupling housing. The sheath can be plastic, rubber, etc. In one embodiment, the sheath comprises a plastic coating, such as a cellophane coating. The user must remove the protective coating before the coupling can be removed. A protective sheath helps prevent the coupling from being discharged accidentally. The sheath acts like the glass that must be broken to remove a fire extinguisher it allows the coupling to remain accessible but the user must actually take affirmative steps to reach the coupling.

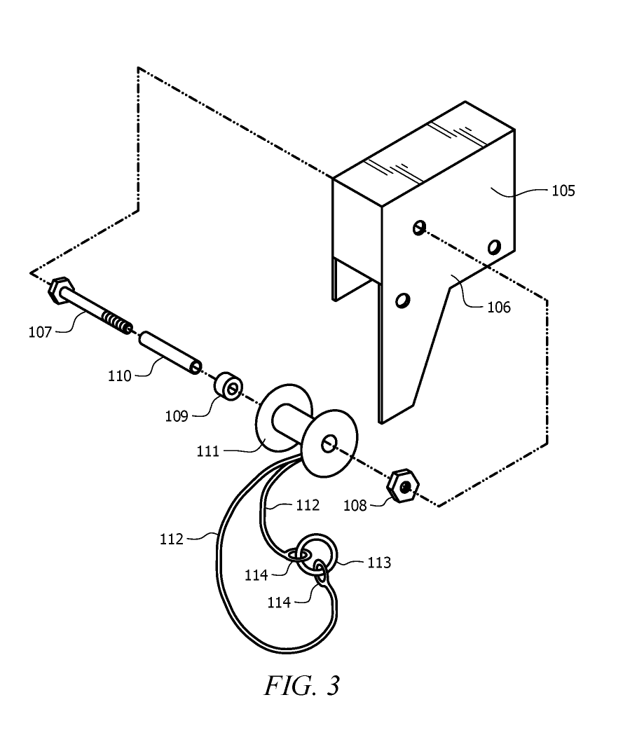

FIG. 3 is a perspective exploded view of a cable housing in one embodiment. One arrangement and specifics for a certain cable housing are addressed in reference to FIG. 3. However, this is for illustrative purposes only and should not be deemed limiting. The layout, various parts, and components, can vary depending upon the desired application of the housing.

As depicted the coupling housing 105 comprises an outer housing 106. As noted, in one embodiment the outer housing 106 comprises a weather proof housing. The housing 106 can comprise virtually any material, including but not limited to, metal, rubber, plastic, wood, and combinations thereof.

The coupling housing 105 further comprises a bolt 107, a corresponding nut 108, a tube 110, a spool 111, a coupling 112, a pull ring 113, a Ferrell 114, and a spacer 109. The items which are used to secure the housing device 105 to the lift are referred to as attaching devices. This can include bolts, screws, welding, etc. This exploded view is for illustrative purposes only and should not be deemed limiting. In the embodiment depicted, a sufficient length of coupling 112, such as a cable, is wound around a spool 111. In the event an occupant becomes stranded, the occupant can pull upon a pulling device, such as the pull ring 113, which will allow the coupling 112 to unravel from the spool 111. The coupling 112 can then be lowered down to the ground where it can be coupled to the equipment 104.

The pulling device, as used herein, refers to an item which aids the user is grabbing the coupling 112. The pulling device can comprise a pull ring 113, as depicted. The ring 113, in one embodiment, is accessible to the passenger and can be used to pull the coupling device 112 out of the housing 105. In other embodiments the pulling device can comprise a leading rope, handle, or other device which facilitates gripping of the coupling 112.

In one embodiment the housing further comprises a lock. A lock, as used herein, prevents the coupling 112 from being released from the housing 105. A benefit of the lock is that it prevents accidental release of the coupling 112. Thus, a lock ensures that the coupling 112 is only released when desired. A lock, in one embodiment, comprises a mechanical device which prevents the accidental release of the coupling 112. The lock can comprise a lever or stop which prevents rotation of the spool, as an example.

As noted, the coupling housing 105 can be attached to the ski lift at virtually any location. It can be attached on the inner compartment, on the external compartment, above the seat, below the seat, etc. It can be stored in any location which is accessible to the stranded occupant.

The coupling housing 105 can be coupled to the ski lift 101 via any method or device known in the art. This includes bolts, screws, welding, etc. As noted, the shape of the outer housing 106 can be modified as necessary to fit and secure within various lifts. Thus, while the lower end of the housing 106 depicted in FIGS. 2 and 3 comprise a wedge shape, this is for illustrative purposes only and should not be deemed limiting.

As noted, in one embodiment the coupling 112 is used to couple to equipment 104. Accordingly, in one embodiment the coupling 112 is not intended to support the entire weight of the occupant. Rather, the equipment 104 will support the weight of the occupant and the coupling 112 only couples and secures the equipment 104 to the lift. In one embodiment, however, the coupling 112 is desired to support the weight of an occupant. Thus, while not intended, if an occupant tethered themselves to the coupling 112, the coupling 112 would not snap.

In one embodiment the housing 105 includes instructions for operation. This allows the occupant to understand that they are to pull upon the pull ring 113, for example, and dangle the coupling 112 to the ground personnel.

The system has been described. Now a method of operating the system will be described. In a situation whereby an elevated lift has malfunctioned and a passenger is needing to exit, the user first locates the housing. The passengers manipulates the housing as necessary to obtain access to the pulling device. This allows the passenger to grip a desired length of coupling. If necessary, the passenger disengages the lock to allow the coupling to be pulled from the housing. The coupling is directed to ground personnel. Thereafter, the ground personnel couple the coupling to ground equipment, such as a ladder.

The coupling can be coupled to ground equipment via any method or device known in the art. In one embodiment the coupler 112 is wrapped around a portion of the ground equipment, such as a rung on the ladder. Thereafter, the coupler 112 is secured to the ground equipment via a lock, chain, etc.

In one embodiment, the coupler 112 is routed to the ground equipment and then looped to secure to itself. In another embodiment the coupler 112 is coupled to ground equipment, such as a rung on a ladder, and then the end of the coupler 112 is routed back to be secured to the housing 105 or the lift 101. However the coupler 112 is secured, there is a secure connection between the lift 101 and the ground equipment. Rather than fearing the ladder, as an example, will fall away from the lift, or depending upon the scared lift occupants to hold the ladder in place, the coupler 112 ensures that the lift 101 is securely coupled to the ground equipment 104.

There are several benefits of the method and system described herein. First is the increased safety of the ground personnel. As noted, often a member of the ground personnel must climb up to the stranded ski lift. Due to the weather, often icy conditions, and the heights involved, this is often dangerous. By allowing the stranded occupants to deploy a coupling, this can reduce or eliminate the need to climb toward the stranded lift.

Second, the method provides increased safety to the stranded occupant. If personnel were unable to secure the lift to the equipment, then often the stranded occupants had to be removed without being able to safely secure the lift to the equipment 104. In such situations, the lift would swing independent of the equipment, making rescue dangerous. By allowing the equipment to be tethered securely to the lift, the safety of the occupant during removal is increased.

Third, this system and method greatly increases the speed of a rescue. Ground equipment can quickly be coupled and decoupled to individual lifts as needed. Thus, the system and method transforms what was previously a slow and deliberate process into a speedy and efficient rescue plan.

While the invention has been particularly shown and described with reference to a preferred embodiment, it will be understood by those skilled in the art that various changes in form and detail may be made therein without departing from the spirit and scope of the invention.

What is claimed is:

1. A coupling housing system, said system comprising:
a housing;
a coupling housed within said housing;
an attaching device for coupling said housing to a lift.

2. The coupling housing system of claim 1 wherein said lift comprises a ski lift.

3. The coupling housing system of claim 1 wherein said coupling comprises a cable.

4. The coupling housing system of claim 1 wherein said coupling is stored on a spool which is located within said housing.

5. The coupling housing system of claim 1 wherein said spool comprises a lock.

6. The coupling housing system of claim 1 wherein said coupling comprises coupling of a length greater than 20 feet.

7. The coupling housing system of claim 1 further comprising a pulling device, wherein said pulling device is partially accessible from outside of the housing.

8. The coupling housing system of claim 1 wherein said coupling housing comprises an external protective sheath.

9. The coupling housing system of claim 8 wherein said protective sheath must be removed prior to removing said coupling from said housing.

10. The coupling housing system of claim 1 wherein said coupling comprises a closed end.

11. The coupling housing system of claim 1 wherein said coupling comprises an open end.

12. A method of rescuing an occupant from a stranded lift, said method comprising:
a) removing a length of a coupling from a coupling housing, wherein said coupling housing is coupled to said lift;
b) lowering said length of coupling to ground personnel below;
c) attaching said coupling to ground equipment;
d) allowing the occupant to exit said lift via said ground equipment, wherein said coupling secures said ground equipment to said stranded lift.

13. The method of claim 12 wherein said ground equipment comprises a ladder.

14. The method of claim 12 wherein said removing further comprises removing a protective sheath.
